(19) United States
(12) Patent Application Publication
(10) Pub. No.: US 2023/0420879 A1
(43) Pub. Date: Dec. 28, 2023

(54) Connector

(71) Applicant: YAMAICHI ELECTRONICS CO., LTD., Tokyo (JP)

(72) Inventors: Yosuke TAKAI, Tokyo (JP); Toshiyasu ITO, Tokyo (JP)

(21) Appl. No.: 18/339,538

(22) Filed: Jun. 22, 2023

Related U.S. Application Data
(60) Provisional application No. 63/354,811, filed on Jun. 23, 2022.

(51) Int. Cl. H01R 13/40

(52) U.S. Cl. CPC H01R 13/40; H01R 12/73

(57) ABSTRACT

Provided is a connector including: a pin group having contact pins aligned in a predetermined direction; an alignment member formed extending in the predetermined direction and having an alignment groove at an end in a width direction orthogonal to the predetermined direction, the alignment groove being for aligning the contact pins; and a conductive member formed extending in the predetermined direction, coupled to the alignment member, and electrically connected to the contact pins used for grounding. The alignment member includes any one of a first protrusion and a first hole configured to accommodate the first protrusion in a center area in the predetermined direction, the conductive member includes the other of the first protrusion and the first hole in the center area in the predetermined direction, and the alignment member and the conductive member are coupled to each other by the first protrusion being secured in the first hole.

### BACKGROUND

### 1. Technical Field

The present invention relates to a connector.

### 2. Description of Related Art

To prevent misalignment of contacts of a connector, there is a technique of using an alignment member having an accommodating chamber made of concave and convex structure to align the tips of contacts continuously arranged in the width direction (for example, Japanese Patent Application Laid-Open No. 2015-204165). Japanese Patent Application Laid-Open No. 2015-204165 discloses that the alignment member is made slidable relative to a housing to which contacts are attached so that the alignment member is less likely to be subjected to thermal impact from the housing.

In recent years, there has been a demand for narrower pitches between contacts in multipole connectors, and further improvement on thermal impact in a reflow process (a process to heat a printed wiring board in a reflow furnace) is required.

Further, high frequency bands (for example, 25 GHz or higher) are required as a frequency band for data transmitted through connectors, and one of the effective methods to ensure good signal transmission characteristics in a high frequency band is to cause a conductive member formed of a conductive resin to come into contact with or come close to a ground pin to absorb noise.

When a host connector in which contacts are aligned by an alignment member and a conductive member absorbs noise is used, however, the conductive member and the alignment member are heated in a reflow process, respectively. When the conductive member and the alignment member have different thermal expansion coefficients, relative misalignment between the conductive member and the alignment member may occur, and this may cause malfunction in the host connector. In particular, when pitches between contacts are narrow and the number of contact pins is large, thermal impact due to a reflow process will be significant.

Accordingly, the present invention intends to provide a connector that can ensure good high frequency characteristics by using a conductive member and ensure position accuracy of contact pins by suppressing misalignment between the conductive member and an alignment member in a reflow process.

### BRIEF SUMMARY

To solve the above problem, the connector of the present invention employs the following solutions.

The connector according to the first aspect of the present invention includes: a pin group having a plurality of contact pins aligned in a predetermined direction; an alignment member formed extending in the predetermined direction and having an alignment groove at an end in a width direction orthogonal to the predetermined direction, the alignment groove being for aligning the plurality of contact pins; and a conductive member formed extending in the predetermined direction, coupled to the alignment member, and electrically connected to the contact pins used for grounding. The alignment member includes any one of a first protrusion and a first hole configured to accommodate the first protrusion in a center area in the predetermined direction, the conductive member includes the other of the first protrusion and the first hole in the center area in the predetermined direction, and the alignment member and the conductive member are coupled to each other by the first protrusion being secured in the first hole.

According to the connector of the first aspect of the present invention, since the conductive member is electrically connected to the contact pins used for grounding, noise is absorbed by the conductive member, and thereby good high frequency characteristics can be ensured.

Further, according to the connector of the first aspect of the present invention, any one of the first protrusion and the first hole of the alignment member and the other of the first protrusion and the first hole of the conductive member are provided in the center area in the predetermined direction, respectively. The alignment member and the conductive member are coupled to each other in the center area by the first protrusion being secured in the first hole.

Since the alignment member and the conductive member are formed extending in the predetermined direction, respectively, the alignment member and the conductive member are subjected to thermal extension in the predetermined direction in a reflow process. Accordingly, since the alignment member and the conductive member are coupled to each other in the center area in the predetermined direction, the distance from the coupling position to the end in the predetermined direction is shorter than that when these members are coupled to each other in the end areas in the predetermined direction. It is thus possible to suppress relative misalignment due to a difference between the amounts of thermal extension of the alignment member and the conductive member.

As described above, according to the connector of the first aspect of the present invention, it is possible to ensure good high frequency characteristics by using the conductive member and ensure position accuracy of the contact pins by suppressing misalignment between the conductive member and the alignment member in a reflow process.

The connector according to the second aspect of the present invention is further configured as below in the first aspect. That is, the alignment member includes any one of a second protrusion and a second hole configured to accommodate the second protrusion in one end side area in the predetermined direction and includes any one of a third protrusion and a third hole configured to accommodate the third protrusion in the other end side area in the predetermined direction, the conductive member includes the other of the second protrusion and the second hole in one end side area in the predetermined direction and includes the other of the third protrusion and the third hole in the other end side area in the predetermined direction, the alignment member and the conductive member are coupled to each other by the second protrusion being secured in the second hole and by the third protrusion being secured in the third hole, and in the predetermined direction, the second hole is longer than the second protrusion, and the third hole is longer than the third protrusion.

According to the connector of the second aspect of the present invention, any one of the second protrusion and the second hole of the alignment member and the other of the second protrusion and the second hole of the conductive member are provided in one end side area in the predetermined direction, respectively. The second protrusion is secured in the second hole, and thereby the alignment member and the conductive member are coupled to each other in the one end side area. Further, any one of the third protrusion and the third hole of the alignment member and the other of the third protrusion and the third hole of the conductive member are provided in the other end side area in the predetermined direction, respectively. The third protrusion is secured in the third hole, and thereby the alignment member and the conductive member are coupled to each other in the other end side area. Thus, the alignment member and the conductive member are reliably coupled to each other in the one end side area and the other end side area in addition to the center area in the predetermined direction.

According to the connector of the second aspect of the present invention, the second hole is longer than the second protrusion, and the third hole is longer than the third protrusion in the predetermined direction. Thus, in a reflow process, when a difference occurs in the amount of thermal extension between the alignment member and the conductive member, the second protrusion moves within a range where the second protrusion does not come into contact with the end of the second hole in the predetermined direction, and the third protrusion moves within a range where the third protrusion does not come into contact with the end of the third hole in the predetermined direction. Accordingly, even when there is a difference in the amount of thermal extension between the alignment member and the conductive member in a reflow process, it is possible to prevent occurrence of stress in accordance with the difference in the amount of thermal extension due to the second protrusion coming into contact with the end of the second hole or prevent occurrence of stress in accordance with the difference in the amount of thermal extension due to the third protrusion coming into contact with the end of the third hole.

The connector according to the third aspect of the present invention is further configured as below in the first aspect. That is, the alignment member includes any one of a second protrusion and a second hole configured to accommodate the second protrusion in one end side area in the predetermined direction and includes any one of a third protrusion and a third hole configured to accommodate the third protrusion in the other end side area in the predetermined direction, the conductive member includes the other of the second protrusion and the second hole in one end side area in the predetermined direction and includes the other of the third protrusion and the third hole in the other end side area in the predetermined direction, the first protrusion includes a plurality of first ribs provided to at least four locations which are on one end side in the predetermined direction, on the other end side in the predetermined direction, and on both end sides in the width direction and extending in a height direction of the first protrusion, the second protrusion includes a plurality of second ribs provided in a different direction from the predetermined direction and extending in a height direction of the second protrusion, the third protrusion includes a plurality of third ribs provided in a different direction from the predetermined direction and extending in a height direction of the third protrusion, and the alignment member and the conductive member are coupled to each other by the first protrusion being press-fitted into the first hole, the second protrusion being press-fitted into the second hole, and the third protrusion being press-fitted into the third hole.

According to the connector of the third aspect of the present invention, since the first ribs are provided on one end side in the predetermined direction and the other end side in the predetermined direction, the first protrusion is press-fitted into the first hole, and thereby the alignment member and the conductive member are positioned in the predetermined direction. Further, since the first ribs are provided on both end sides in the width direction, the first protrusion is press-fitted into the first hole, and thereby the alignment member and the conductive member are positioned in the width direction. In such a way, since the alignment member and the conductive member are positioned both in the predetermined direction and the width direction. Therefore, even when the alignment member and the conductive member are thermally expanded, a state where the center areas of both the members have been positioned can be maintained.

Further, according to the connector of the third aspect of the present invention, any one of the second protrusion and the second hole of the alignment member and the other of the second protrusion and the second hole of the conductive member are provided in one end side area in the predetermined direction, respectively. The second protrusion is press-fitted into the second hole, and thereby the alignment member and the conductive member are coupled to each other in one end side area. Further, any one of the third protrusion and the third hole of the alignment member and the other of the third protrusion and the third hole of the conductive member are provided in the other end side area in the predetermined direction, respectively. The third protrusion is press-fitted into the third hole, and thereby the alignment member and the conductive member are coupled to each other in the other end side area. Thus, the alignment member and the conductive member are reliably coupled to each other in one end side area and the other end side area in addition to the center area in the predetermined direction.

The connector according to the fourth aspect of the present invention is further configured as below in any one of the first aspect to the third aspect. That is, the connector includes a housing that holds the pin group, the alignment member includes a pair of first fixing parts protruding in the predetermined direction and fixed to the housing, the conductive member includes a pair of second fixing parts protruding in the predetermined direction and fixed to the housing, the pair of first fixing parts and the pair of second fixing parts are in contact with each other in a state where the alignment member is coupled to the conductive member, the housing includes a pair of fixing grooves in which the pair of first fixing parts and the pair of second fixing parts are secured in a state where the alignment member is coupled to the conductive member, and the alignment member and the conductive member are coupled to the housing by the pair of first fixing parts and the pair of second fixing parts being secured in the pair of fixing grooves.

According to the connector of the fourth aspect of the present invention, in a state where the alignment member is coupled to the conductive member, the pair of first fixing parts of the alignment member and the pair of second fixing parts of the conductive member are in contact with each other and are secured in the pair of fixing grooves provided in the housing. This makes it possible to maintain the state where the alignment member is coupled to the conductive member and fix the alignment member and the conductive member to the housing.

The connector according to the fifth aspect of the present invention is further configured as below in the fourth aspect. That is, the alignment member and the conductive member are coupled to the housing by the pair of first fixing parts and the pair of second fixing parts being press-fitted into the pair of fixing grooves.

According to the connector of the fifth aspect of the present invention, in a state where the alignment member is coupled to the conductive member, the pair of first fixing parts of the alignment member and the pair of second fixing parts of the conductive member are in contact with each other and are press-fitted into the pair of fixing grooves provided in the housing.

This makes it possible to maintain the state where the alignment member is coupled to the conductive member and fix the alignment member and the conductive member to the housing.

### BRIEF DESCRIPTION OF THE SEVERAL VIEWS OF THE DRAWINGS

FIG. 1 is a perspective view of a module mounted on a mount substrate.

FIG. 2 is a sectional view taken along a cut line A-A illustrated in FIG. 1.

FIG. 3 is a perspective view of a host connector when viewed from above front.

FIG. 4 is a perspective view of the host connector when viewed from above back.

FIG. 5 is a transverse sectional view of the host connector.

FIG. 6 is a transverse sectional view of a housing of the host connector.

FIG. 7 is an exploded perspective view of the host connector when viewed from above back.

FIG. 8 is a perspective view of a part of a top pin group.

FIG. 9 is a perspective view of a part of a bottom pin group.

FIG. 10 is a perspective view of a conductive member and an alignment member not coupled to each other when viewed from below back.

FIG. 11 is a perspective view of the conductive member and the alignment member coupled to each other when viewed from below back.

FIG. 12 is a perspective view of the alignment member when viewed from above back.

FIG. 13 is a plan view of the alignment member when viewed from above.

FIG. 14 is a bottom view of the conductive member when viewed from below.

FIG. 15 is a transverse sectional view of a first protrusion of the alignment member.

FIG. 16 is a transverse sectional view of a second protrusion and a third protrusion of the alignment member.

FIG. 17 is an enlarged back view near a press-fit groove of the host connector from which a back plate has been removed.

FIG. 18 is an enlarged perspective view near the press-fit groove of the host connector from which the back plate has been removed.

FIG. 19 is a perspective view of the back face of one end of the host connector (before the back plate is fused).

FIG. 20 is a perspective view of the back face of one end of the host connector (after the back plate has been fused).

FIG. 21 is a back view of the host connector from which the back plate has been removed.

FIG. 22 is a sectional view taken along a cut line B-B illustrated in FIG. 21.

FIG. 23 is a sectional view in a state where the back plate is attached to the host connector illustrated in FIG. 22.

FIG. 24 is a perspective view of a plug connector when viewed from above back.

### DETAILED DESCRIPTION

A connector according to one embodiment of the present disclosure will be described below with reference to Figures.

The connector of the present embodiment is a device that electrically connects a module 320 and a mount substrate 310 (substrate) to each other.

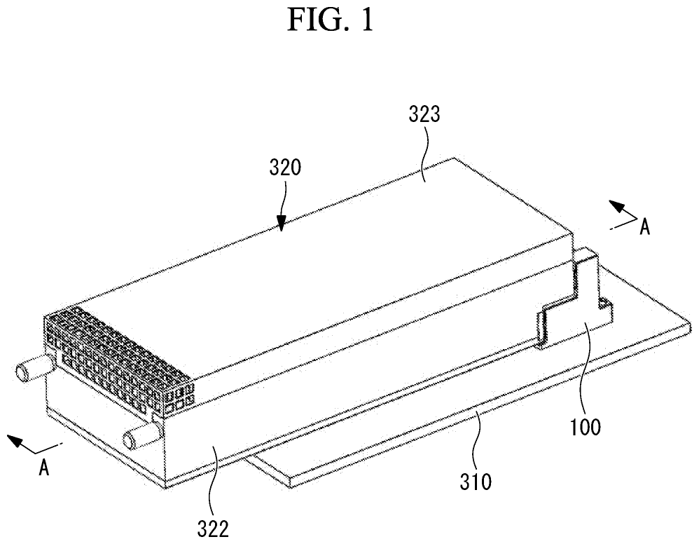

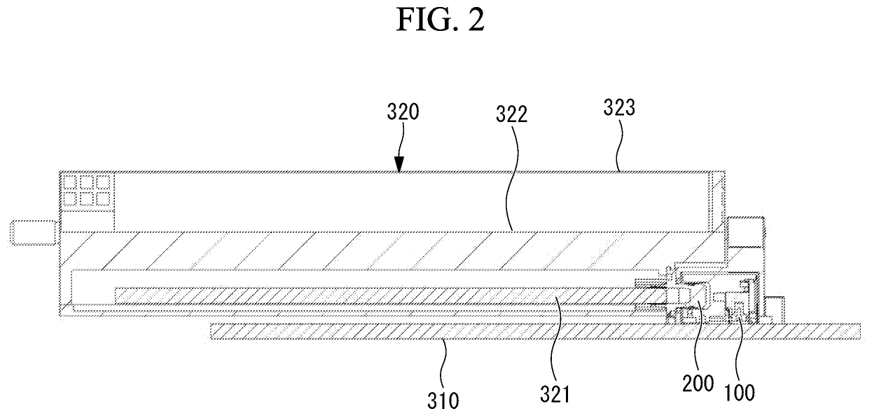

As illustrated in FIG. 1 and FIG. 2, the module 320 has a plug connector substrate 321 and a cage 322 that accommodates the plug connector substrate 321. Further, for efficient cooling, a heatsink 323 may be installed on the top face of the cage 322.

The plug connector substrate 321 is electrically connected to the mount substrate 310 via a host connector 100 mounted on the mount substrate 310 and via a plug connector 200 that connects the host connector 100 and the plug connector substrate 321 to each other.

The connector of the present embodiment corresponds to the host connector 100 and/or the plug connector 200 described above. These connectors are adapted for ultrahigh-speed transmission.

Note that the “ultrahigh-speed transmission” as used herein refers to high-speed transmission exceeding 100 Gbps using a PAM4 modulation scheme, for example.

[Host Connector]

The host connector 100 will be described below.

<Summary of Configuration of Host Connector>

The host connector 100 is a connector that is mounted on the mount substrate 310 and in which the plug connector 200 is inserted, that is, a connector for connecting the mount substrate 310 and the plug connector 200 to each other.

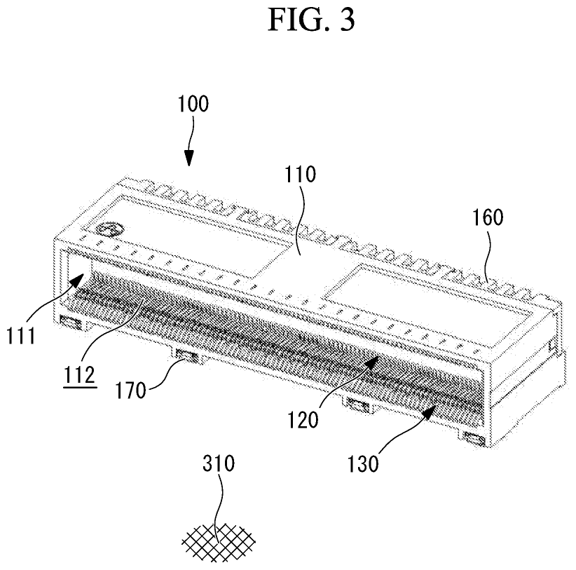

As illustrated in FIG. 3 to FIG. 7, the host connector 100 includes a housing 110, a top pin group 120, a bottom pin group 130, a conductive member 140, an alignment member 150, and a back plate 160 (back face member).

The housing 110 is a component having substantially a rectangular parallelepiped external shape and accommodates and holds the top pin group 120, the bottom pin group 130, the conductive member 140, and the alignment member 150.

The housing 110 is molded from a resin or the like, for example, and is a nonconductive member.

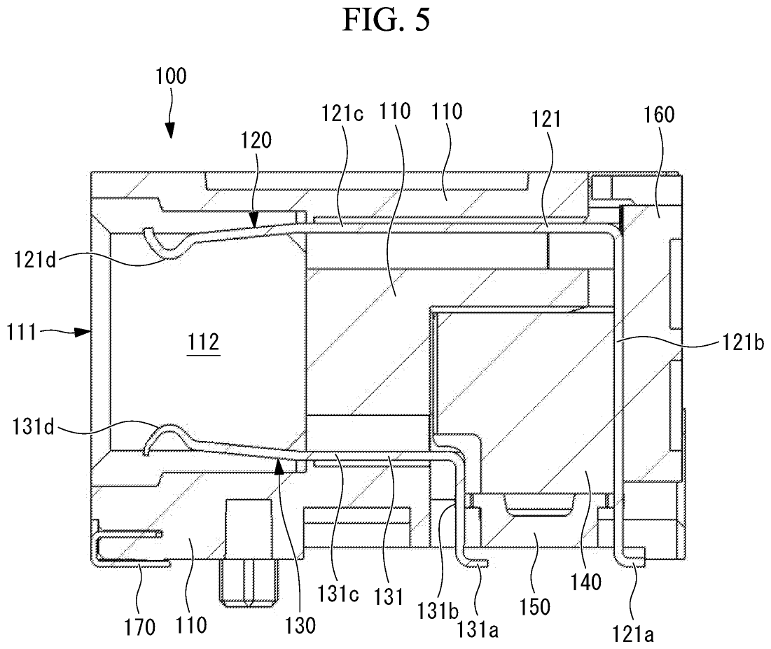

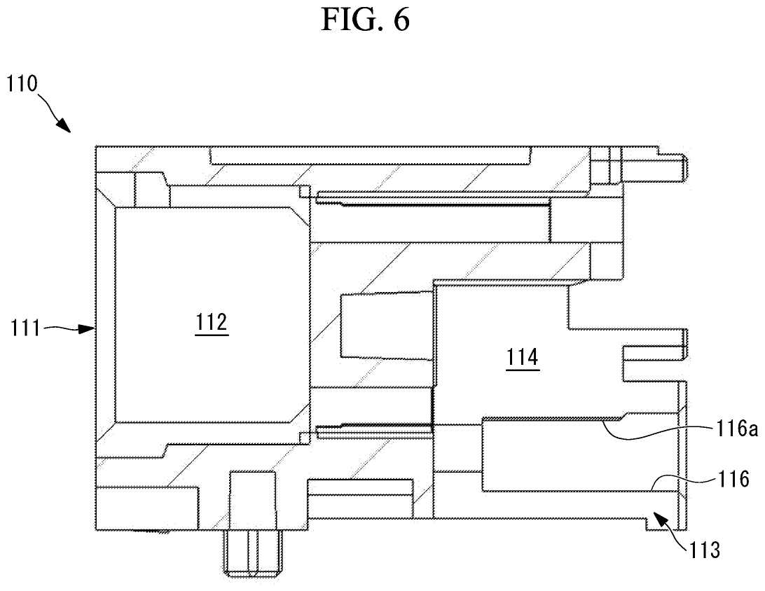

As illustrated in FIG. 5 and FIG. 6, a plug insertion space 112 and a member accommodating space 114 are formed inside the housing 110.

A front opening 111 communicating with the plug insertion space 112 is opened in the front face of the housing 110.

A back opening 113 communicating with the member accommodating space 114 is provided in a part of the back face and the bottom face of the housing 110.

The plug insertion space 112 is a space in which the plug connector 200 is inserted via the front opening 111.

The member accommodating space 114 is a space in which the conductive member 140 and the alignment member 150 are accommodated.

Further, each contact pin of the top pin group 120 and the bottom pin group 130 is accommodated across the plug insertion space 112 and the member accommodating space 114.

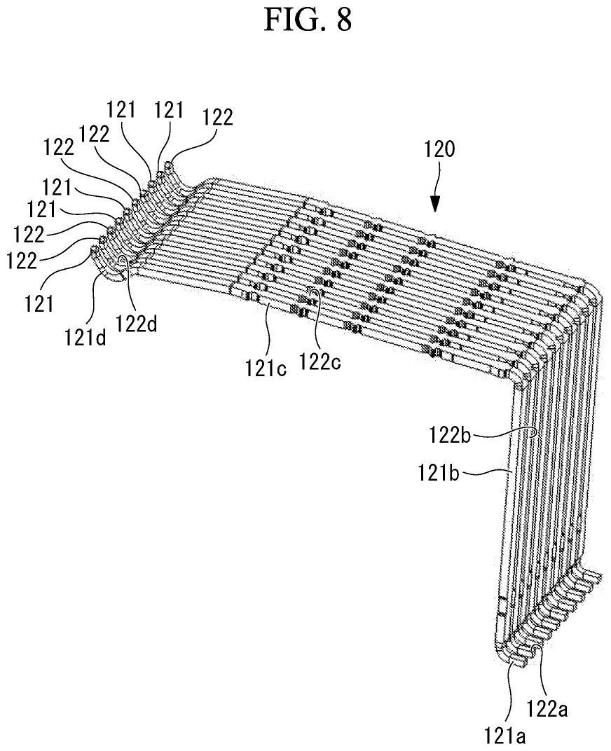

As illustrated in FIG. 8, the top pin group 120 is a group of contact pins configured such that a plurality of top ground pins 121 and a plurality of top signal pins 122 are aligned in a predetermined direction.

In the top pin group 120, the plurality of top ground pins 121 and the plurality of top signal pins 122 are aligned in accordance with a predetermined rule. The details thereof will be described later.

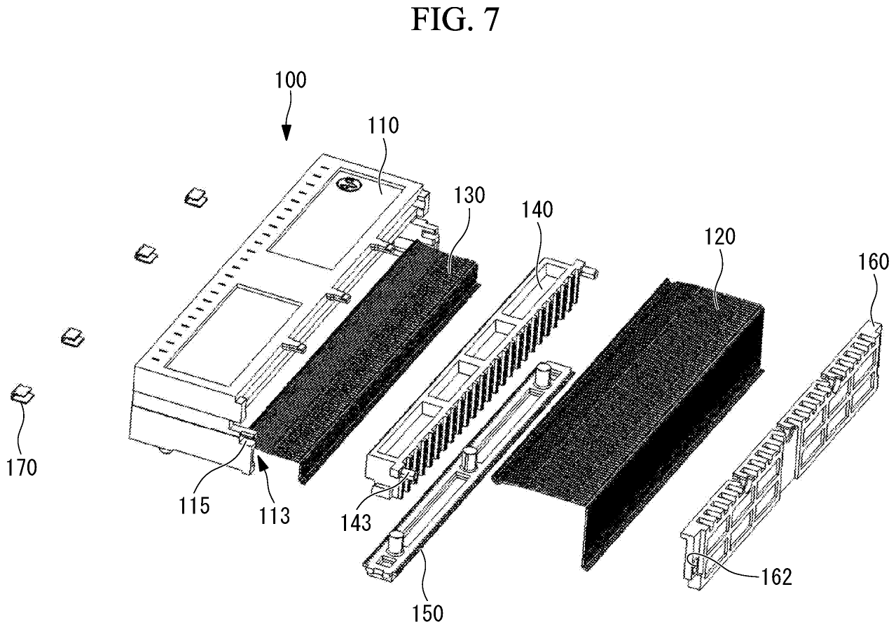

As illustrated in FIG. 7, the alignment direction of these contact pins of the top pin group 120 matches the longitudinal direction of the housing 110.

Each top ground pin 121 is an elongated metal terminal for electrical conduction and has a mount portion 121a, an erect portion 121b, and a substantially-straight portion 121c.

The mount portion 121a is a portion mounted on the mount substrate 310 and extends in the horizontal direction on the base end side of the top ground pins 121.

The erect portion 121b is a portion erecting from the mount portion 121a at substantially a right angle (in substantially the vertical direction in FIG. 8). The longitudinal dimension of the erect portion 121b is sufficiently larger than the longitudinal dimension of the mount portions 121a.

The substantially-straight portion 121c is a portion extending from the erect portion 121b at substantially a right angle (in substantially the horizontal direction in FIG. 8).

The longitudinal dimension of the substantially-straight portion 121c is sufficiently larger than the longitudinal dimension of the mount portion 121a. Further, the longitudinal dimension of the substantially-straight portion 121c is preferably larger than the longitudinal dimension of the erect portion 121b.

A contact point part 121d bent convex toward the plug insertion space 112 (see FIG. 5) is formed on the tip side of the substantially-straight portion 121c. The contact point part 121d serves as a contact point with a top ground pin 221 of the plug connector 200 described later. As illustrated in FIG. 5, a part of the substantially-straight portion 121c including the contact point part 121d extends outward to the plug insertion space 112.

Each top signal pin 122 is an elongated metal terminal for electrical conduction and has a mount portion 122a, an erect portion 122b, and a substantially-straight portion 122c.

The configurations of the mount portion 122a, the erect portion 122b, and the substantially-straight portion 122c are the same as the configurations of the mount portion 121a, the erect portion 121b, and the substantially-straight portion 121c of the top ground pin 121.

Note that the contact point part 122d formed to the substantially-straight portion 122c serves as a contact point with a top signal pin 222 of the plug connector 200 described later.

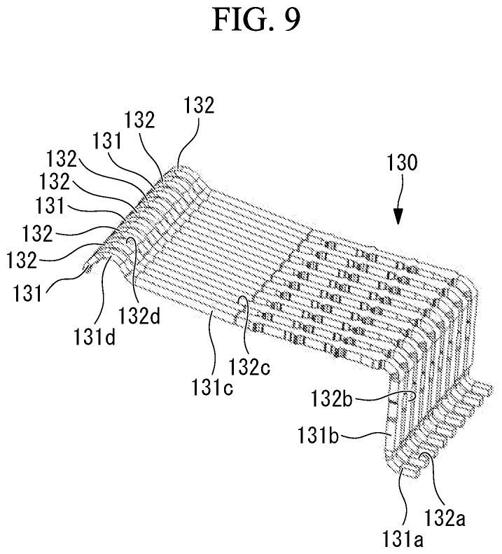

As illustrated in FIG. 9, the bottom pin group 130 is a group of contact pins configured such that a plurality of bottom ground pins 131 and a plurality of bottom signal pins 132 are aligned in the predetermined direction.

In the bottom pin group 130, the plurality of bottom ground pins 131 and the plurality of bottom signal pins 132 are aligned. The details thereof will be described later.

As illustrated in FIG. 7, the alignment direction of these contact pins of the bottom pin group 130 matches the longitudinal direction of the housing 110.

Each bottom ground pin 131 is an elongated metal terminal for electrical conduction and has a mount portion 131a, an erect portion 131b, and a substantially-straight portion 131c.

The mount portion 131a is a portion mounted on the mount substrate 310 and extends in the horizontal direction on the base end side of the bottom ground pins 131.

The erect portion 131b is a portion erecting from the mount portion 131a at substantially a right angle (in substantially the vertical direction in FIG. 9). The longitudinal dimension of the erect portion 131b is larger than the longitudinal dimension of the mount portions 131a.

The substantially-straight portion 131c is a portion extending from the erect portion 131b at substantially a right angle (in substantially the horizontal direction in FIG. 9).

The longitudinal dimension of the substantially-straight portion 131c is sufficiently larger than the longitudinal dimension of the mount portion 131a. Further, the longitudinal dimension of the substantially-straight portion 131c is larger than the longitudinal dimension of the erect portion 131b.

A contact point part 131d bent convex toward the plug insertion space 112 (see FIG. 5) is formed on the tip side of the substantially-straight portion 131c. The contact point part 131d serves as a contact point with a bottom ground pin of the plug connector 200 described later. As illustrated in FIG. 5, a part of the substantially-straight portion 131c including the contact point part 131d extends outward to the plug insertion space 112.

Each bottom signal pin 132 is an elongated metal terminal for electrical conduction and has a mount portion 132a, an erect portion 132b, and a substantially-straight portion 132c.

The configurations of the mount portion 132a, the erect portion 132b, and the substantially-straight portion 132c are the same as the configurations of the mount portion 131a, the erect portion 131b, and the substantially-straight portion 131c of the bottom ground pin 131.

Note that the contact point part 132d formed to the substantially-straight portion 132c serves as a contact point with a bottom signal pin 232 of the plug connector 200 described later.

In a state where the top pin group 120 and the bottom pin group 130 are assembled to the housing 110 and a state where the host connector 100 is mounted on the mount substrate 310, the top pin group 120 (in detail, the substantially-straight portion 121c and the substantially-straight portion 122c) is arranged so as to be located above the bottom pin group 130 (in detail, the substantially-straight portion 131c and the substantially-straight portion 132c) and face the bottom pin group 130 inside the housing 110, as illustrated in FIG. 3 and FIG. 5.

In other words, the bottom pin group 130 is arranged so as to be located below the top pin group 120 inside the housing 110 and face the top pin group 120. That is, the bottom pin group 130 is arranged at a closer position to the mount substrate 310 than the top pin group 120 (arranged at a position on the mount substrate 310 side) in a state where the host connector 100 is mounted on the mount substrate 310.

As illustrated in FIG. 5 to FIG. 7 and FIG. 10, the conductive member 140 is substantially a rectangular parallelepiped block-like component.

As illustrated in FIG. 5, the conductive member 140 is accommodated in the member accommodating space 114 inside the housing 110 in a state where the alignment member 150 is attached to the bottom face.

The conductive member 140 is a member having predetermined conductivity and is molded from a resin in which conductive particles are dispersed, an antistatic resin, or the like, for example. For example, the “predetermined conductivity” as used herein is greater than or equal to 10 S/m and less than or equal to 200 S/m and, preferably, greater than or equal to 30 S/m and less than or equal to 150 S/m.

The conductive member 140 is a member formed extending in a longitudinal direction (predetermined direction) LD, coupled to the alignment member 150, and electrically connected to the top ground pins (contact pins for grounding) 121 of the top pin group 120 and the bottom ground pins (contact pins for grounding) 131 of the bottom pin group 130 for conduction between these pins.

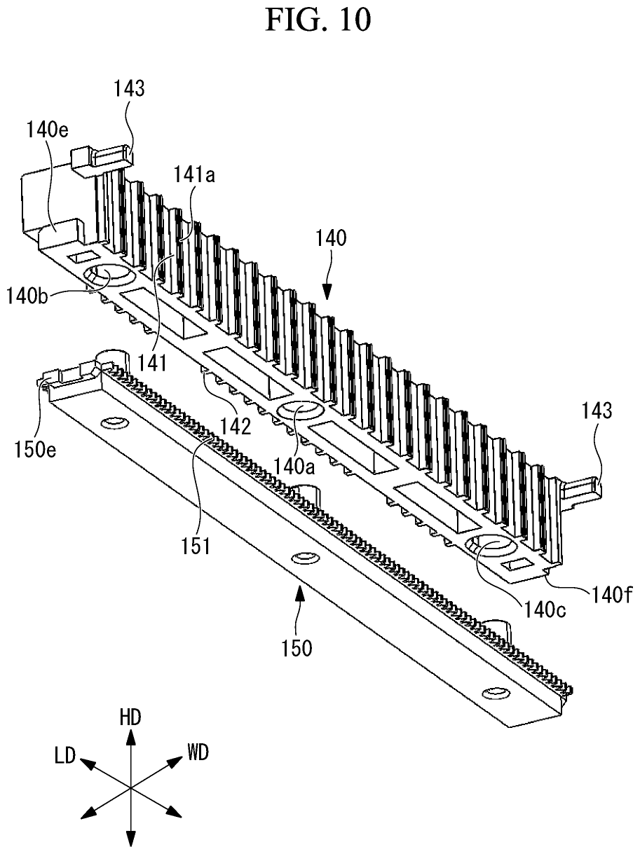

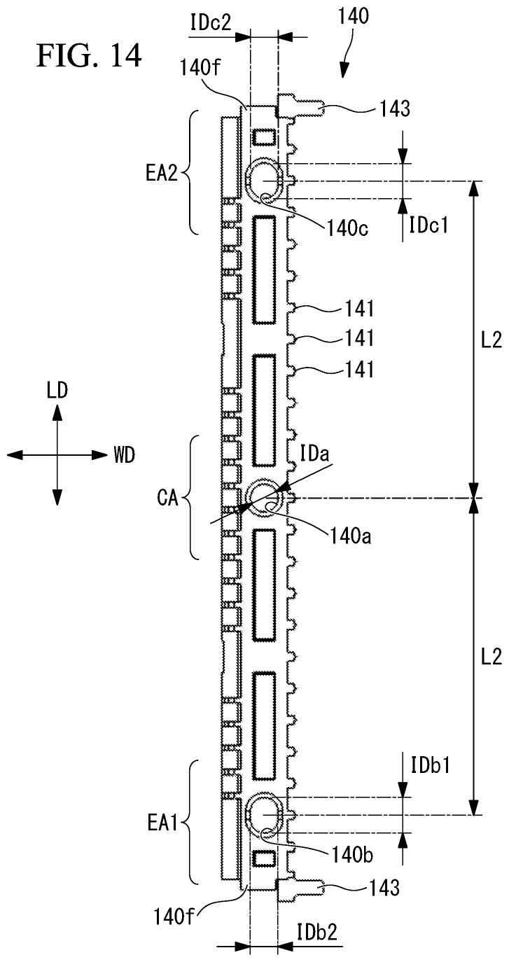

As illustrated in FIG. 10, the conductive member 140 has a first hole 140a, a second hole 140b, and a third hole 140c starting at the lower end in the height direction HD and extending in the height direction HD, respectively. As illustrated in the bottom view of FIG. 14, the first hole 140a is arranged in a center area CA in the longitudinal direction LD of the conductive member 140. The second hole 140b is arranged in an end area EA1 (one end side area) in the longitudinal direction LD of the conductive member 140. The third hole 140c is arranged in an end area EA2 (the other end side area) in the longitudinal direction LD of the conductive member 140.

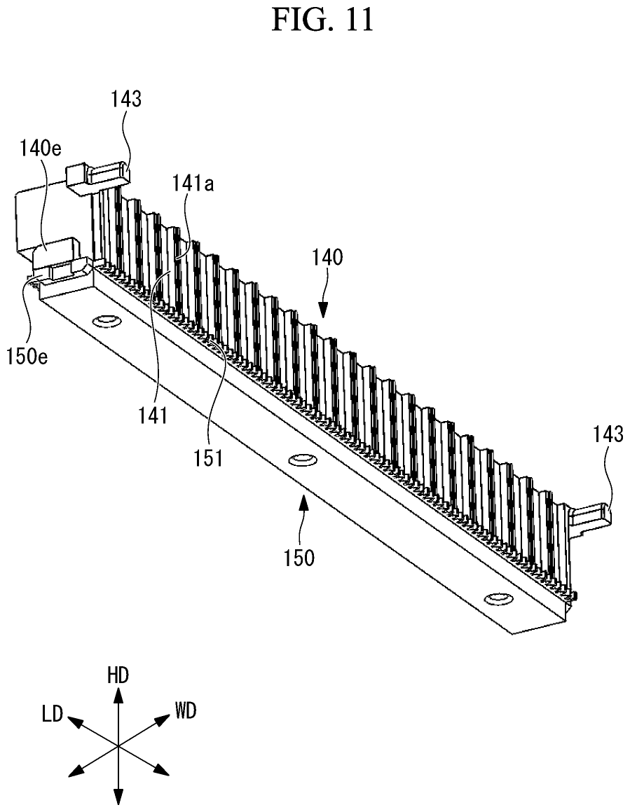

As illustrated in FIG. 5 to FIG. 7 and FIG. 10 to FIG. 12, the alignment member 150 is substantially a rectangular plate-like member formed extending in the longitudinal direction LD that is an alignment direction of respective contact pins of the top pin group 120 and the bottom pin group 130. As illustrated in FIG. 10 and FIG. 11, in the alignment member 150, the length in the longitudinal direction LD is longer than the length in a width direction WD orthogonal to the longitudinal direction LD.

As illustrated in FIG. 5 and FIG. 6, the alignment member 150 is attached to the bottom face of the conductive member 140 and, in this state, accommodated in the member accommodating space 114 inside the housing 110.

The alignment member 150 is molded from a resin or the like, for example, and is a nonconductive member having no conductivity.

As illustrated in FIG. 10 to FIG. 12, a plurality of back side alignment grooves 151 are formed at constant intervals in the longitudinal direction LD at the end of the alignment member 150 on one side (on the back opening 113 side) in the width direction WD. Further, a plurality of front side alignment grooves 152 are formed at constant intervals in the longitudinal direction LD at the end of the alignment member 150 on the other side (on the front opening 111 side) in the width direction WD.

The front side alignment grooves 152 each accommodate each contact pin forming the bottom pin group 130 and thereby align a plurality of contact pins at equal pitches.

The back side alignment grooves 151 each accommodate each contact pin forming the top pin group 120 and thereby align a plurality of contact pins at equal pitches.

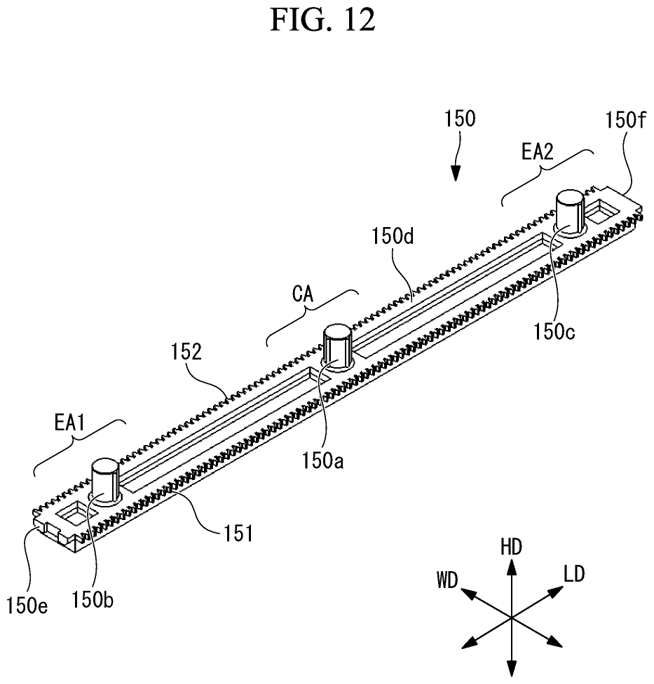

As illustrated in FIG. 12, the alignment member 150 has a body 150d formed in a plate shape, a first protrusion 150a, a second protrusion 150b, and a third protrusion 150c that protrude in the height direction HD from the body 150d. The first protrusion 150a is arranged in the center area CA in the longitudinal direction LD of the body 150d. The second protrusion 150b is arranged in the end area EA1 (one end side area) in the longitudinal direction LD of the body 150d. The third protrusion 150c is arranged in the end area EA2 (the other end side area) in the longitudinal direction LD of the body 150d.

The alignment member 150 and the conductive member 140 are coupled to each other by the first protrusion 150a being press-fitted into the first hole 140a, the second protrusion 150b being press-fitted into the second hole 140b, and the third protrusion 150c being press-fitted into the third hole 140c.

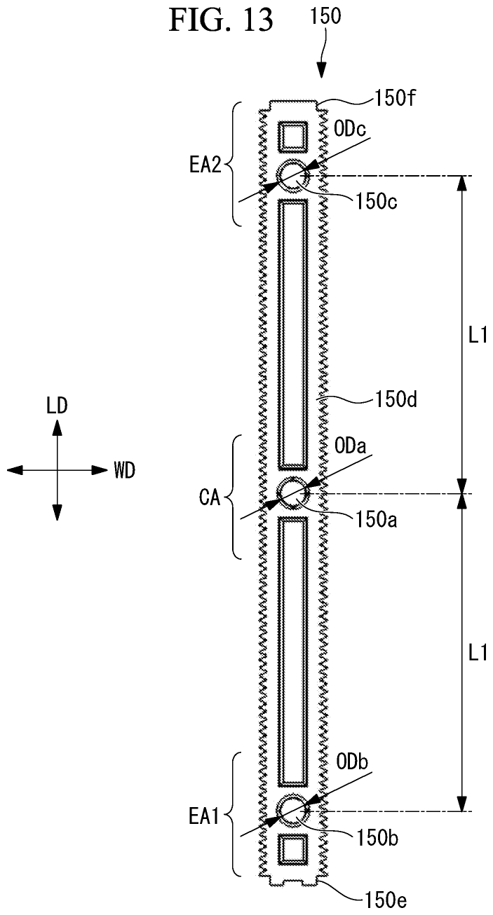

As illustrated in the plan view of FIG. 13, each of the first protrusion 150a, the second protrusion 150b, and the third protrusion 150c of the alignment member 150 is a member that is circular in a planar view. The outer diameters of the first protrusion 150a, the second protrusion 150b, and the third protrusion 150c are ODa, ODb, ODc, respectively. The outer diameters ODa, ODb, ODc are the same, for example, but may differ from each other.

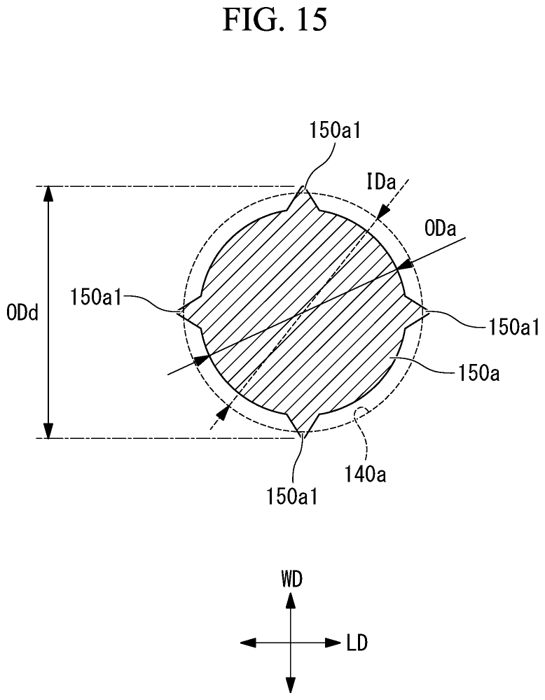

As illustrated in FIG. 15, the first protrusion 150a has first ribs 150a1 in four locations which are on one end side in the longitudinal direction LD, on the other end side in the longitudinal direction LD, and on both end sides in the width direction WD. The first ribs 150a1 extend in the height direction HD of the first protrusion 150a and protrude in the radial direction outward from the center of the first protrusion 150a. Note that, although FIG. 15 illustrates the example in which the first ribs 150a1 are arranged in four locations at intervals, the first ribs 150a1 may be arranged in any of four or more locations (for example, 8 locations at 45-degree intervals).

As illustrated in FIG. 14, the first hole 140a of the conductive member 140 is a hole that is circular in a planar view and has an inner diameter of IDa. As illustrated in FIG. 15, the outer diameter ODa of the first protrusion 150a is smaller than the inner diameter IDa of the first hole 140a. On the other hand, the outer diameter ODd of the first protrusion 150a at a position where a pair of the first ribs 150a1 are arranged spaced at intervals of 180 degrees is larger than the inner diameter IDa of the first hole 140a.

Thus, when the first protrusion 150a is inserted in the first hole 140a, ridges of the first ribs 150a1 are partially deformed, and the first protrusion 150a can be press-fitted into the first hole 140a. Since the first protrusion 150a is in a state where the first ribs 150a1 in four locations at 90-degree intervals are in contact with the inner circumferential face of the first hole 140a, respectively, the alignment member 150 is fixed so as not to move both in the longitudinal direction LD and the width direction WD relative to the conductive member 140.

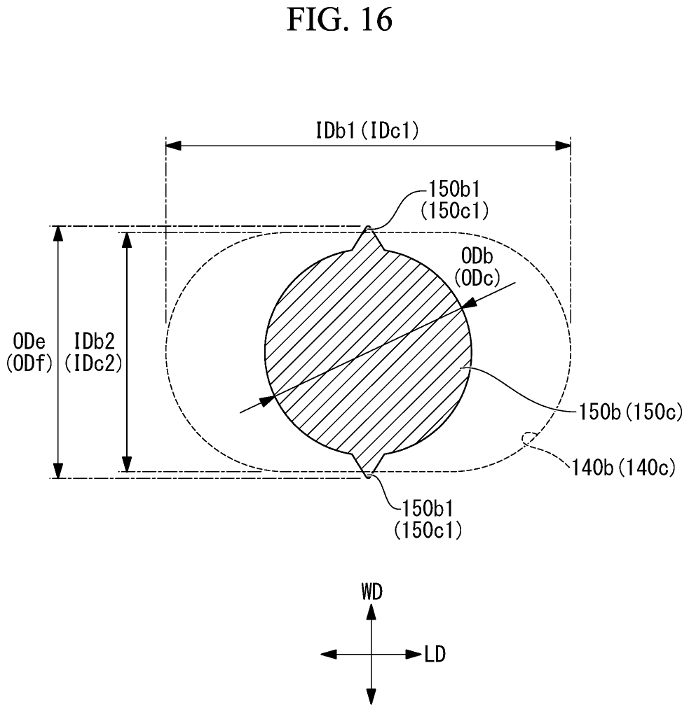

As illustrated in FIG. 16, the second protrusion 150b has second ribs 150b1 in two locations which are on both end sides in the width direction WD that is different from the longitudinal direction LD. The second ribs 150b1 extend in the height direction HD of the second protrusion 150b and protrude in the radial direction outward from the center of the second protrusion 150b. The third protrusion 150c has third ribs 150c1 in two locations which are on both end sides in the width direction WD that is different from the longitudinal direction LD. The third ribs 150c1 extend in the height direction HD of the third protrusion 150c and protrude in the radial direction outward from the center of the third protrusion 150c.

The second hole 140b of the conductive member 140 is substantially an elliptical or circular hole having an inner diameter of IDb1 in the longitudinal direction LD and an inner diameter of IDb2 in the width direction WD. The inner diameter IDb1 is the same as the inner diameter of IDb2 or larger than the inner diameter IDb2. The inner diameter IDb1 is preferably in a range that is larger than or equal to one fold and smaller than or equal to two fold of the inner diameter IDb2. The third hole 140c of the conductive member 140 is substantially an elliptical or circular hole having an inner diameter of IDc1 in the longitudinal direction LD and an inner diameter of IDc2 in the width direction WD. The inner diameter IDc1 is the same as the inner diameter of IDc2 or larger than the inner diameter IDc2. The inner diameter IDc1 is preferably in a range that is larger than or equal to one fold and smaller than or equal to two fold of the inner diameter IDc2.

As illustrated in FIG. 16, the outer diameter ODb of the second protrusion 150b is smaller than the inner diameter IDb2 of the second hole 140b in the width direction WD. On the other hand, the outer diameter ODe of the second protrusion 150b at a position where a pair of the second ribs 150b1 are arranged spaced at intervals of 180 degrees is larger than the inner diameter IDb2 of the second hole 140b in the width direction WD. The outer diameter ODc of the third protrusion 150c is smaller than the inner diameter IDc2 of the third hole 140c in the width direction WD. On the other hand, the outer diameter ODf of the third protrusion 150c at a position where a pair of the third ribs 150c1 are arranged spaced at intervals of 180 degrees is larger than the inner diameter IDc2 of the third hole 140c in the width direction WD.

Thus, when the second protrusion 150b is inserted in the second hole 140b, ridges of the second ribs 150b1 are partially deformed, and the second protrusion 150b can be press-fitted into the second hole 140b. Since the second protrusion 150b is in a state where the second ribs 150b1 in two locations at 180-degree intervals are in contact with the inner circumferential face of the second hole 140b, respectively, the alignment member 150 is fixed so as not to be rotated about the first protrusion 150a relative to the conductive member 140.

Further, when the third protrusion 150c is inserted in the third hole 140c, ridges of the third ribs 150c1 are partially deformed, and the third protrusion 150c can be press-fitted into the third hole 140c. Since the third protrusion 150c is in a state where the third ribs 150c1 in two locations at 180-degree intervals are in contact with the inner circumferential face of the third hole 140c, respectively, the alignment member 150 is fixed so as not to be rotated about the first protrusion 150a relative to the conductive member 140.

As illustrated in FIG. 14 and FIG. 16, in the present embodiment, the second hole 140b of the conductive member 140 is longer than the second protrusion 150b of the alignment member 150, and the third hole 140c of the conductive member 140 is longer than the third protrusion 150c of the alignment member 150 in the longitudinal direction LD. The reason for employing the above feature is to, even when there is a difference in the amount of thermal extension between the alignment member 150 and the conductive member 140 in a reflow process, prevent occurrence of stress in accordance with the difference in the amount of thermal extension due to the second protrusion 150b coming into contact with the end of the second hole 140b or prevent occurrence of stress in accordance with the difference in the amount of thermal extension due to the third protrusion 150c coming into contact with the end of the third hole 140c.

As illustrated in FIG. 13, in the alignment member 150 at room temperature when no reflow process is ongoing, each of the distance in the longitudinal direction LD from the center of the first protrusion 150a to the center of the second protrusion 150b and the distance in the longitudinal direction LD from the center of the first protrusion 150a to the center of the third protrusion 150c is L1.

Further, as illustrated in FIG. 14, in the conductive member 140 at room temperature where no reflow process is ongoing, each of the distance in the longitudinal direction LD from the center of the first hole 140a to the center of the second hole 140b and the distance in the longitudinal direction LD from the center of the first hole 140a to the center of the third hole 140c is L2.

The distance L1 and the distance L2 are set such that, in a state where the first protrusion 150a has been press-fitted into the first hole 140a, the second protrusion 150b is not in contact with the end in the longitudinal direction LD of the second hole 140b and the third protrusion 150c is not in contact with the end in the longitudinal direction LD of the third hole 140c. For example, the distance L1 is set equal to the distance L2.

FIG. 16 illustrates a state where the conductive member 140 and the alignment member 150 have been coupled to each other at room temperature where no reflow process is ongoing. As illustrated in FIG. 16, at room temperature, a space is formed between the end in the longitudinal direction LD of the second protrusion 150b and the end in the longitudinal direction LD of the second hole 140b. Similarly, at room temperature, a space is formed between the end in the longitudinal direction LD of the third protrusion 150c and the end in the longitudinal direction LD of the third hole 140c.

In a reflow process, when the conductive member 140 and the alignment member 150 are coupled to each other and heated, the amount of thermal extension in the longitudinal direction LD of the conductive member 140 may be larger than the amount of thermal extension in the longitudinal direction LD of the alignment member 150 due to the difference in the thermal expansion coefficient between the conductive member 140 and the alignment member 150. Further, the amount of thermal extension in the longitudinal direction LD of the conductive member 140 may be smaller than the amount of thermal extension in the longitudinal direction LD of the alignment member 150.

In such a case, the position of the second protrusion 150b relative to the second hole 140b moves in the longitudinal direction LD, and the position of the third protrusion 150c relative to the third hole 140c moves in the longitudinal direction LD. However, since clearances are formed between the second hole 140b and the second protrusion 150b and between the third hole 140c and the third protrusion 150c in the longitudinal direction LD, it is possible to prevent the second protrusion 150b from coming into contact with the end in the longitudinal direction LD of the second hole 140b or prevent the third protrusion 150c from coming into contact with the end in the longitudinal direction LD of the third hole 140c.

Although, in the above description, the first protrusion 150a, the second protrusion 150b, and the third protrusion 150c are formed on the alignment member 150 and the first hole 140a, the second hole 140b, and the third hole 140c are formed in the conductive member 140, other forms may be possible. For example, the first hole 140a, the second hole 140b, and the third hole 140c may be formed in the alignment member 150 and the first protrusion 150a, the second protrusion 150b, and the third protrusion 150c may be formed on the conductive member 140.

As illustrated in FIG. 5 and FIG. 6, the back plate 160 is a block-like component having substantially a rectangular external shape.

As illustrated in FIG. 5, the back plate 160 is attached to the back face of the housing 110 so as to close a part of the back opening 113 of the housing 110.

The back plate 160 is molded from a resin or the like, for example. The back plate 160 may be a member having conductivity or a member having no conductivity.

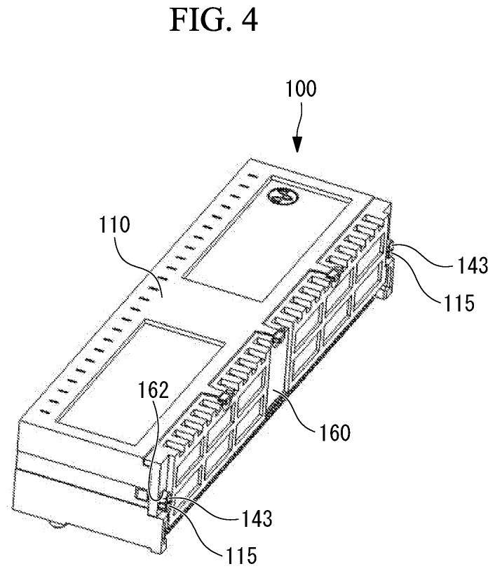

As illustrated in FIG. 3 and FIG. 4, the housing 110, the top pin group 120, the bottom pin group 130, the conductive member 140, the alignment member 150, and the back plate 160 configured as described above are assembled, and thereby the host connector 100 is configured.

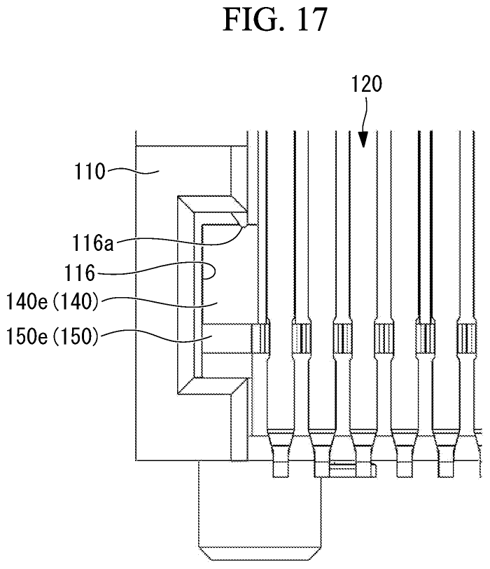

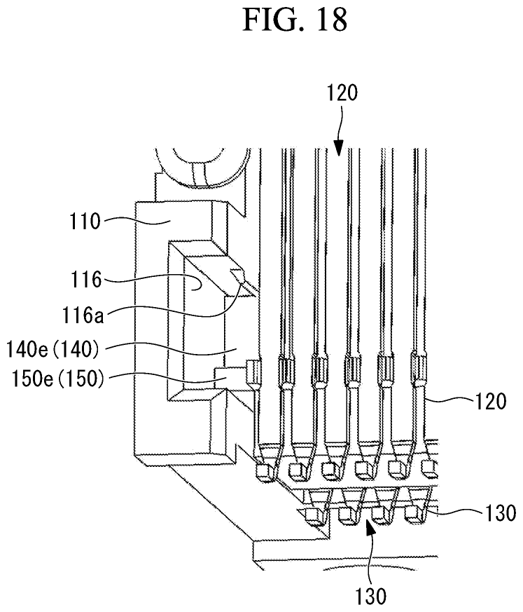

In this state, as illustrated in FIG. 17 and FIG. 18, the assembly of the conductive member 140 and the alignment member 150 (see FIG. 11) is fixed to the housing 110 by both the ends thereof being press-fitted into the press-fit groove (fixing groove) 116 formed in both inner faces of the housing 110.

Specifically, a crush rib 116a formed on the top face of the press-fit groove 116 is crushed by the conductive member 140, and thereby both ends of the assembly are press-fitted into the press-fit groove 116.

As illustrated in FIG. 10 and FIG. 13, the alignment member 150 has a pair of first fixing parts 150e, 150f protruding in the longitudinal direction LD and fixed to the housing 110. The conductive member 140 has a pair of second fixing parts 140e, 140f protruding in the longitudinal direction LD and fixed to the housing 110. As illustrated in FIG. 11, in a state where the alignment member 150 is coupled to the conductive member 140, the pair of first fixing parts 150e, 150f and the pair of the second fixing parts 140e, 140f are in contact with each other.

As illustrated in FIG. 17 and FIG. 18, the first fixing part 150e and the second fixing part 140e are press-fitted into the press-fit groove 116 in a state where the alignment member 150 is coupled to the conductive member 140, and thereby the alignment member 150 and the conductive member 140 are coupled to the housing 110. Although depiction is omitted, the first fixing part 150f and the second fixing part 140f are press-fitted into the press-fit groove (the same one as the press-fit groove 116 is formed at the end in the longitudinal direction LD of the housing 110) in a state where the alignment member 150 is coupled to the conductive member 140, and thereby the alignment member 150 and the conductive member 140 are coupled to the housing 110.

Further, as illustrated in FIG. 5, the bottom pin group 130 is positioned by the alignment member 150 fixed to the housing 110 and, in this state, pressed and fixed to the housing 110.

Further, as illustrated in FIG. 6, substantially semicircular protrusions 115 (convex downward) are formed at both ends of the housing 110. Further, as illustrated in FIG. 10, substantially semicircular protrusions 143 (convex upward) are formed at both ends of the conductive member 140.

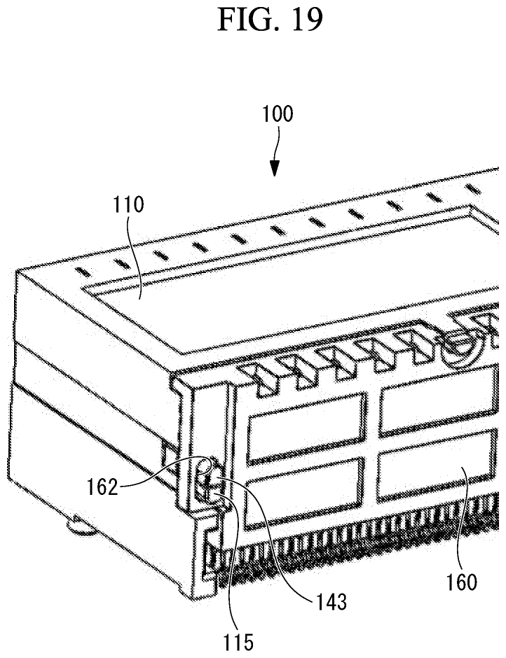

Further, as illustrated in FIG. 19, when the assembly of the conductive member 140 and the alignment member 150 is accommodated in the housing 110, each protrusion 115 and each protrusion 143 are matched to each other, and thereby a single shaft-like part is formed at each end.

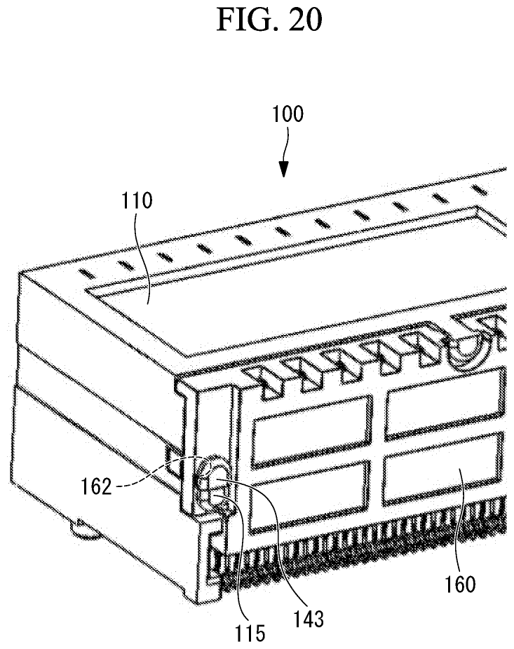

Further, as illustrated in FIG. 19 and FIG. 20, the tip of each shaft-like part is fused to the back plate 160 in a state where each shaft-like part is inserted in a fixing hole 162 formed at both ends of the back plate 160, and thereby the back plate 160 is fixed to the back face of the housing 110.

Further, as illustrated in FIG. 5, the top pin group 120 is positioned by the alignment member 150 fixed to the housing 110 and, in this state, pressed and fixed by the back plate 160.

In the host connector 100 configured as described above, as illustrated in FIG. 3, a fixing bracket 170 attached to the housing 110 and the contact pins are soldered to the mount substrate 310.

The fixing bracket 170 is soldered to the mount substrate 310, and thereby the host connector 100 can be rigidly fixed to the mount substrate 310. Further, the contact pins are soldered to the mount substrate 310, and thereby the host connector 100 can be fixed to the mount substrate 310, and these contact pins can be electrically connected to the mount substrate 310.

<Details of Alignment of Contact Pins and Arrangement of Pin Groups>

As illustrated in FIG. 8, in the top pin group 120, when the top ground pin 121 is denoted as “G”, and the top signal pin 122 is denoted as “S”, the contact pins are aligned as G-S-S-G-G-S-S-G- . . . -G-S-S-G. That is, a plurality of sets of G-S-S-G in which two top signal pins 122 forming a differential pair are aligned between two top ground pins 121 are aligned in the predetermined direction. In this state, G located at the end (for example, the right end) of the first set and G located at the end (for example, the left end) of the second set are adjacent to each other.

In the present embodiment, such alignment is referred to as “double ground configuration”. By employing the double ground configuration, it is possible to reduce crosstalk during ultrahigh-speed transmission.

As illustrated in FIG. 9, in the bottom pin group 130, the bottom pin group 130 has a portion aligned as G-S-S-G-S-S-G- . . . -S-S-G, for example.

As described above, when the top pin group 120 (in detail, the substantially-straight portion 121c and the substantially-straight portion 122c) is arranged above the bottom pin group 130 (in detail, the substantially-straight portion 131c and the substantially-straight portion 132c) inside the housing 110, more space becomes available above the top pin group 120, as illustrated in FIG. 1 and FIG. 2.

In contrast, no more space becomes available on the bottom pin group 130 side because of the presence of the mount substrate 310.

Since high-speed signals are arranged in the top pin group 120 to which the double ground configuration is employed, the top pin group 120 is more likely to generate heat during ultrahigh-speed transmission than the bottom pin group 130. However, with arrangement of the top pin group 120 located above the bottom pin group 130, the heatsink 323 for cooling the top pin group 120 can be arranged in the space ensured by this arrangement.

In other words, the top pin group 120, which is likely to generate heat, is positively arranged above the housing 110 where an enough space is available and easy installation of the heatsink 323 or the like is possible.

Note that the double ground configuration may be employed to only the top pin group 120 or may be employed to the top pin group 120 and the bottom pin group 130.

<Details of Conductive Member>

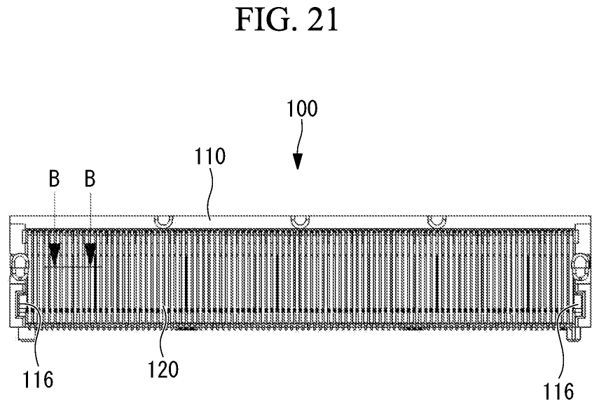

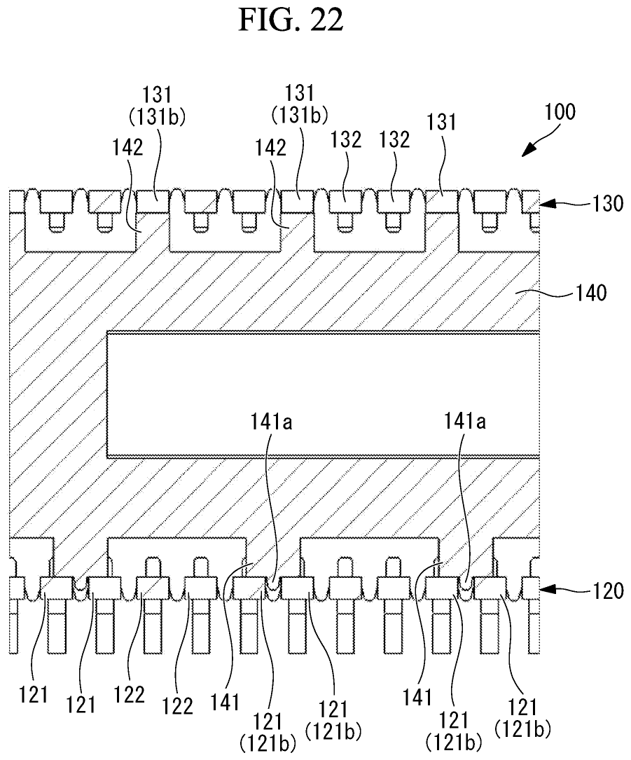

FIG. 21 illustrates a back view of the host connector 100 from which the back plate 160 has been removed. Further, FIG. 22 illustrates a sectional view taken along the cut line B-B illustrated in FIG. 21.

As illustrated in FIG. 10 and FIG. 22, a plurality of back side contact convex parts 141 are formed on the back face of the conductive member 140.

Each back side contact convex part 141 is a protruding part extending in the height direction (thickness direction) of the conductive member 140 and is formed at equal pitches over the longitudinal direction of the conductive member 140.

As illustrated in FIG. 5 and FIG. 22, the back side contact convex part 141 is electrically connected to the front faces of the erect portions 121b of adjacent two top ground pins 121 in the top pin group 120. Accordingly, since the top ground pins 121 are electrically connected to the conductive member 140 having conductivity, noise can be attenuated.

Herein, the back side contact convex part 141 may be in physical contact with the top ground pins 121, or a slight clearance may be provided between the back side contact convex part 141 and the top ground pins 121. The “slight clearance” as used herein is a clearance of a spacing having a distance between which a high frequency field of 1 GHz or higher can be electrically connected and, for example, ranges from 0.05 mm to 0.1 mm. Note that the back side contact convex part 141 is neither in physical contact nor electrical contact with the top signal pins 122.

A ridge 141a (protruding shape) is formed on the surface of each back side contact convex part 141.

The ridge 141a is an elongated protrusion extending in the height direction (thickness direction) of the conductive member 140, and a single ridge 141a is formed in the center area of each back side contact convex part 141.

The ridge 141a protrudes toward a region between the top ground pin 121 and the top ground pin 121, and this increases the area of the conductive member 140 in which the ridge 141a is arranged between the top ground pin 121 and the top ground pin 121 and faces these top ground pins 121.

As illustrated in FIG. 10 and FIG. 22, a plurality of front side contact convex parts 142 are formed on the front face of the conductive member 140.

Each front side contact convex part 142 is a protruding part extending in the height direction (thickness direction) of the conductive member 140 and is formed at equal pitches over the longitudinal direction of the conductive member 140.

As illustrated in FIG. 5 and FIG. 22, the front side contact convex part 142 is electrically connected to the back faces of the erect portions 131b of the bottom ground pins 131 in the bottom pin group 130. Accordingly, since the bottom ground pins 131 are electrically connected to the conductive member 140 having conductivity, noise can be attenuated.

Herein, the front side contact convex part 142 may be in physical contact with the bottom ground pin 131, or a slight clearance may be provided between the front side contact convex part 142 and the bottom ground pin 131. The “slight clearance” as used herein is a clearance of a spacing having a distance between which a high frequency field of 1 GHz or higher can be electrically connected and, for example, ranges from 0.05 mm to 0.1 mm.

Note that the front side contact convex part 142 is neither in physical contact nor electrical contact with the bottom signal pins 132.

Further, when the bottom pin group 130 employs the double ground configuration, the front side contact convex part 142 may have the same form as the back side contact convex part 141.

As illustrated in FIG. 5, the dimension in the height direction of the conductive member 140 is greater than or equal to 50% of the dimension of the erect portion 121b of the top ground pin 121.

Thus, the back side contact convex part 141 (including the ridge 141a) is in contact with a range of 50% or greater of the erect portion 121b of the top ground pin 121.

Further, to realize this, the conductive member 140 is required to be larger in the height direction, and such a case necessarily results in a larger ratio that the conductive member 140 occupies the member accommodating space 114 inside the housing 110.

This can improve noise attenuation performance allowed by the conductive member 140.

Note that it is preferable that the conductive member 140 occupy 50% to 90% of the member accommodating space 114.

<Details of Back Plate>

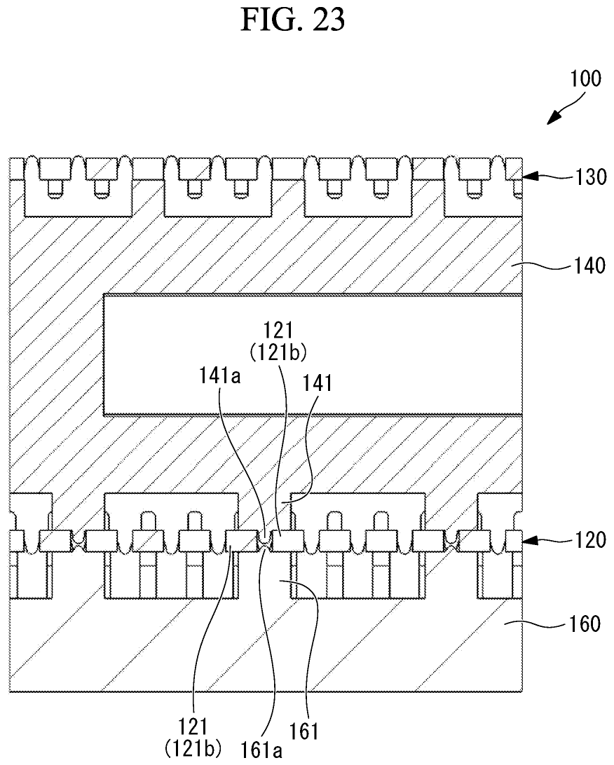

FIG. 23 illustrates a state where the back plate 160 is attached to the host connector 100 illustrated in FIG. 22.

As illustrated in FIG. 23, a plurality of contact convex parts 161 are formed on the front face of the back plate 160.

Each contact convex part 161 is a protruding part extending in the height direction (thickness direction) of the back plate 160 and is formed at equal pitches over the longitudinal direction of the back plate 160.

As illustrated in FIG. 5 and FIG. 23, the contact convex part 161 is contacted on the back faces of the erect portions 121b of adjacent two top ground pins 121 in the top pin group 120.

As illustrated in FIG. 23, since the position of the contact convex part 161 corresponds to the position of the back side contact convex part 141, the top ground pin 121 can be held between the contact convex part 161 and the back side contact convex part 141. Accordingly, the top ground pin 121 can be pushed against the back side contact convex part 141 to improve the contact property.

Further, since the conductive member 140 is pressed to the bottom ground pin 131 side by the pressing force applied to the top ground pin 121 from the back plate 160, as a result, the front side contact convex part 142 can be pushed against the bottom ground pin 131 to improve the contact property.

A ridge 161a is formed on the surface of each contact convex part 161.

The ridge 161a is an elongated protrusion extending in the height direction (thickness direction) of the back plate 160, and a single ridge 161a is formed in the center area of each contact convex part 161.

The ridge 161a protrudes toward a region between the top ground pin 121 and the top ground pin 121, and this increases the area of the back plate 160 which faces these top ground pins 121.

[Plug Connector]

The plug connector 200 will be described below.

<Summary of Configuration of Plug Connector>

The plug connector 200 is a connector that is inserted in the host connector 100 and in which the plug connector substrate 321 is inserted, that is, a connector for connecting the host connector 100 and the plug connector substrate 321 to each other.

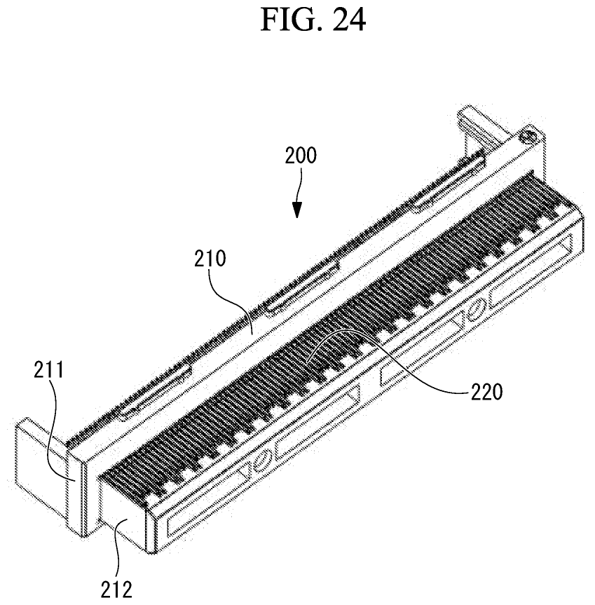

As illustrated in FIG. 24, the plug connector 200 includes a housing 210, a top pin group 220, and a bottom pin group (not shown).

The housing 210 is a component having a plate-like part 211 and a protruding part 212 protruding from the back face of the plate-like part 211 and accommodates and holds the top pin group 120 and the bottom pin group.

The housing 210 is a nonconductive member and is molded from a resin or the like, for example.

[Effects and Advantages of Connector]

The host connector 100 of the present embodiment achieves the following effects and advantages.

According to the connector of the present embodiment, the first protrusion 150a of the alignment member 150 and the first hole 140a of the conductive member 140 are provided in the center area CA in the longitudinal direction LD, respectively. The alignment member 150 and the conductive member 140 are coupled to each other in the center area CA by the first protrusion 150a being press-fitted in the first hole 140a.

Since the alignment member 150 and the conductive member 140 are formed extending in the longitudinal direction LD, respectively, the alignment member 150 and the conductive member 140 are subjected to thermal extension along the longitudinal direction LD in a reflow process. Accordingly, since the alignment member 150 and the conductive member 140 are coupled to each other in the center area CA in the longitudinal direction LD, the distance from the coupling position to the end in the longitudinal direction LD is shorter than that when these members are coupled to each other in the end areas EA1, EA2 in the longitudinal direction LD. It is thus possible to suppress relative misalignment due to a difference between the amounts of thermal extension of the alignment member 150 and the conductive member 140.

As described above, according to the host connector 100 of the present embodiment, it is possible to provide a connector that can improve high frequency characteristics by absorbing noise through electrical connection of the conductive member to the contact pins used for grounding and suppress relative misalignment between the conductive member 140 and the alignment member 150 in a reflow process.

According to the host connector 100 of the present embodiment, the second protrusion 150b of the alignment member 150 and the second hole 140b of the conductive member 140 are provided in one end side area in the longitudinal direction, respectively. The second protrusion 150b is press-fitted into the second hole 140b, and thereby the alignment member 150 and the conductive member 140 are coupled to each other in one end side area. Further, the third protrusion 150c of the alignment member 150 and the third hole 140c of the conductive member 140 are provided in the other end side area in the longitudinal direction LD, respectively. The third protrusion 150c is press-fitted into the third hole 140c, and thereby the alignment member 150 and the conductive member 140 are coupled to each other in the other end side area. Thus, the alignment member 150 and the conductive member 140 are reliably coupled to each other in one end side area and the other end side area in addition to the center area CA in the longitudinal direction LD.

According to the host connector 100 of the present embodiment, the second hole 140b is longer than the second protrusion 150b, and the third hole 140c is longer than the third protrusion 150c in the longitudinal direction LD. Thus, in a reflow process, when a difference occurs in the amount of thermal extension between the alignment member 150 and the conductive member 140, the second protrusion 150b moves within a range where the second protrusion 150b does not come into contact with the end in the longitudinal direction LD of the second hole 140b, and the third protrusion 150c moves within a range where the third protrusion 150c does not come into contact with the end in the longitudinal direction LD of the third hole 140c. Accordingly, even when there is a difference in the amount of thermal extension between the alignment member 150 and the conductive member 140 in a reflow process, it is possible to prevent occurrence of stress in accordance with the difference in the amount of thermal extension due to the second protrusion coming into contact with the end of the second hole or prevent occurrence of stress in accordance with the difference in the amount of thermal extension due to the third protrusion 150c coming into contact with the end of the third hole 140c.

According to the host connector 100 of the present embodiment, since the first ribs 150a1 are provided on one end side in the longitudinal direction LD and the other end side in the longitudinal direction LD, the first protrusion 150a is press-fitted into the first hole 140a, and thereby the alignment member 150 and the conductive member 140 are positioned in the longitudinal direction LD. Further, since the first ribs 150a1 are provided on both end sides in the width direction WD, the first protrusion 150a is press-fitted into the first hole 140a, and thereby the alignment member 150 and the conductive member 140 are positioned in the width direction WD. In such a way, the alignment member 150 and the conductive member 140 are positioned both in the longitudinal direction LD and the width direction WD. Therefore, even when the alignment member 150 and the conductive member 140 are thermally expanded, a state where the center areas CA of both the members are positioned can be maintained.

According to the host connector 100 of the present embodiment, in a state where the alignment member 150 is coupled to the conductive member 140, the pair of first fixing parts 150e, 150f of the alignment member 150 and the pair of second fixing parts 140e, 140f of the conductive member 140 are in contact with each other and press-fitted into the pair of press-fit grooves 116 provided in the housing 110. This makes it possible to maintain the state where the alignment member 150 is coupled to the conductive member 140 and fix the alignment member 150 and the conductive member 140 to the housing 110.

Note that the double ground configuration of the top pin groups 120, 220 is not an essential configuration in the embodiment described above.

What is claimed is:

1. A connector comprising:
a pin group having a plurality of contact pins aligned in a predetermined direction;
an alignment member formed extending in the predetermined direction and having an alignment groove at an end in a width direction orthogonal to the predetermined direction, the alignment groove being for aligning the plurality of contact pins; and
a conductive member formed extending in the predetermined direction, coupled to the alignment member, and electrically connected to the contact pins used for grounding,
wherein the alignment member includes any one of a first protrusion and a first hole configured to accommodate the first protrusion in a center area in the predetermined direction,
wherein the conductive member includes the other of the first protrusion and the first hole in the center area in the predetermined direction, and
wherein the alignment member and the conductive member are coupled to each other by the first protrusion being secured in the first hole.

2. The connector according to claim 1,
wherein the alignment member includes any one of a second protrusion and a second hole configured to accommodate the second protrusion in one end side area in the predetermined direction and includes any one of a third protrusion and a third hole configured to accommodate the third protrusion in the other end side area in the predetermined direction,
wherein the conductive member includes the other of the second protrusion and the second hole in one end side area in the predetermined direction and includes the other of the third protrusion and the third hole in the other end side area in the predetermined direction,
wherein the alignment member and the conductive member are coupled to each other by the second protrusion being secured in the second hole and by the third protrusion being secured in the third hole, and
wherein the second hole is longer than the second protrusion, and the third hole is longer than the third protrusion in the predetermined direction.

3. The connector according to claim 1,
wherein the alignment member includes any one of a second protrusion and a second hole configured to accommodate the second protrusion in one end side area in the predetermined direction and includes any one of a third protrusion and a third hole configured to accommodate the third protrusion in the other end side area in the predetermined direction,
wherein the conductive member includes the other of the second protrusion and the second hole in one end side area in the predetermined direction and includes the other of the third protrusion and the third hole in the other end side area in the predetermined direction,
wherein the first protrusion includes a plurality of first ribs provided to at least four locations which are on one end side in the predetermined direction, on the other end side in the predetermined direction, and on both end sides in the width direction and extending in a height direction of the first protrusion,
wherein the second protrusion includes a plurality of second ribs provided in a different direction from the predetermined direction and extending in a height direction of the second protrusion,
wherein the third protrusion includes a plurality of third ribs provided in a different direction from the predetermined direction and extending in a height direction of the third protrusion, and
wherein the alignment member and the conductive member are coupled to each other by the first protrusion being press-fitted into the first hole, the second protrusion being press-fitted into the second hole, and the third protrusion being press-fitted into the third hole.

4. The connector according to claim 1 further comprising a housing that holds the pin group,
wherein the alignment member includes a pair of first fixing parts protruding in the predetermined direction and fixed to the housing,
wherein the conductive member includes a pair of second fixing parts protruding in the predetermined direction and fixed to the housing,
wherein the pair of first fixing parts and the pair of second fixing parts are in contact with each other in a state where the alignment member is coupled to the conductive member,
wherein the housing includes a pair of fixing grooves in which the pair of first fixing parts and the pair of second fixing parts are secured in a state where the alignment member is coupled to the conductive member, and
wherein the alignment member and the conductive member are coupled to the housing by the pair of first fixing parts and the pair of second fixing parts being secured in the pair of fixing grooves.

5. The connector according to claim 4, wherein the alignment member and the conductive member are coupled to the housing by the pair of first fixing parts and the pair of second fixing parts being press-fitted into the pair of fixing grooves.
